(19) United States
(12) Patent Application Publication
(10) Pub. No.: US 2011/0192850 A1
(43) Pub. Date: Aug. 11, 2011

(54) CULINARY ARTICLE COMPRISING A NON-STICK COATING HAVING IMPROVED NON-STICK PROPERTIES

(75) Inventors: Stéphanie Le Bris, Challes Les Eaux (FR); Aurélien Dubanchet, Gresy Sur Aix (FR); Jean-Luc Perillon, Saint Paul Trois Chateaux (FR)

(73) Assignee: SEB SA, Ecully (FR)

(21) Appl. No.: 13/000,906

(22) PCT Filed: Aug. 24, 2009
(86) PCT No.: PCT/FR2009/051621

§ 371 Date: Apr. 25, 2011

(30) Foreign Application Priority Data
Aug. 29, 2008 (FR) 0855830

(51) Int. Cl. A47J 36/02; B05D 7/22

(52) U.S. Cl. 220/573.2; 427/230

(57) ABSTRACT

A culinary article comprising a vitreous type coating which has improved non-stick properties. The present invention also relates to a process for manufacturing such an article.

### PRIORITY CLAIM

The present application is a National Phase entry of PCT Application No. PCT/FR2009/051621, filed Aug. 24, 2009, 2009, which claims priority from French Application No. 0855830, filed Aug. 29, 2008, the disclosures of which are hereby incorporated by reference herein in their entirety.

### TECHNICAL FIELD

The present invention generally relates to culinary articles comprising a non-stick coating, and more particularly culinary articles whereof the internal side is covered with a non-stick vitreous type coating having improved non-stick properties. The present invention also relates to a process for manufacturing such an article.

### BACKGROUND ART

By vitreous-type coating, is meant herein a coating which looks like glass or enamel, which can be either organo-mineral, or entirely mineral;

By organo-mineral vitreous type coating is meant herein, a coating made from a sol-gel type material (i.e., obtained by a sol-gel process) whereof the network is substantially inorganic, but which comprises organic groups, especially due to the precursors used and the curing temperature of the coating.

By entirely mineral coating, is meant, herein, a coating constituted of an entirely inorganic material, free from all organic groups. Such a coating may also be obtained by sol-gel process with a curing temperature of at least 400° C., or based on tetraethoxysilane type precursors (TEOS) with a curing temperature which can be less than 400° C.

By coating having improved non-stick properties, is meant, herein, a coating that can be easily cleaned and which enables to cook food with very little or even without fat. Such a coating is hence able to resist to adherence, particularly after cooking, of the substances from oil degradation, fat and foods in general.

In the field of non-stick vitreous type coatings intended for culinary utensils, one already knows the enamel-based coatings, however these do not guarantee a good anti-adherence, and require high vitrification temperatures (higher than 540° C.).

One also knows the sol-gel coatings, particularly obtained from silica-based (silanes) or alumina-based (aluminates) metal alkoxides. However, such coatings do not allow to deposit an important thickness and usually craze in thicknesses of around 10 microns. Furthermore, their cohesion is only completed if high temperatures are applied during long periods of time, for example temperatures higher than 400° C. during at least thirty minutes. However, this type of coating enables to consider a user range for higher temperatures than PTFE-based coatings, which can particularly go up to 600° C., instead of 300° C. maximum for PTFE-based coatings.

However, the drawbacks of such coatings are that they exhibit non-stick properties that are not only limited but are also hardly durable, this rendering them difficult to apply as coatings covering the internal side of the bottom of a culinary article.

To remedy these issues, the skilled person is known to add fluorinated elements especially fluorinated silanes, in sol-gel coatings obtained by the condensation of silanes. Thus, the European patent application EP 1 835 002 describes non-stick coatings which comprise a base layer applied onto a substrate and an upper layer applied on a base layer. The base layer is composed of a silica-based matrix, resulting from the condensation of an organoalkoxysilane and a colloidal silica sol. The upper layer is also composed of a silica-based matrix resulting from the condensation of an organoalkoxysilane with a colloidal silica sol, but with the particularity that the organoalkoxysilane further comprises a low quantity of a fluoroalkoxysilane (FAS).

However, the drawbacks of incorporating fluorinated silanes in sol-gel type coatings are that these components are not only costly but are also of limited thermal stability, thus being prejudicial to their maintaining in film, particularly in the case of high temperature steaming. In fact, fluorine emission cannot be prevented and thus, they are no longer distinguishable from non modified sol-gel coatings due to the disappearance of fluorinated molecular segments favorable to the non-stick properties.

Moreover, the skilled person is known to macroscopically structure the surface of the internal side of a culinary article which is coated with a fluorocarbon-based organic coating and especially a PTFE-type coating. The use of such structured bottoms in fact enables the improvement of the non-stick properties of this type of coating. Thus, the patents of MEYER EP 0259056 and EP 0415705 (anodized aluminium substrate) describe culinary utensils whereof the inside surface to be in contact with food is achieved with waves that delimit very close crests, thus forming a wavy surface whereon a non-stick material such as PTFE can be applied.

Meanwhile, this solution is only seldom or not used at all as the resistance to abrasion particularly at the ridges of the relief is very low. In fact, since it is a particularly used area, one may notice the appearance of non coated areas, and thus even after limited usage of the utensil, which severely harms the non-stick properties of the inside surface of the article.

Sol-gel type coatings such as those obtained from metal alkoxides exhibit, with respect to PTFE-type fluorocarbon coatings, a better resistance to abrasion, which is a measure of greater wearability at the ridges. However, the sol-gel coatings have very limited non-stick properties.

Consequently, the skilled person knowing the above-mentioned MEYER patents would be naturally led to use structured bottoms to improve the non-stick properties of such coatings. However, since these sol-gel formulations are very fluid by nature, it is very noticeable in the case of a structured bottom that the covering of the ridges remains thinner than the rest of the surface.

In order to improve this covering of ridges of relief, particularly at the ridges, it is known by the skilled person to thicken the coating formulation by means of a thickening agent of organic nature. The most frequently used agents in the framework of sol-gels are usually xanthan gums but can also be derived from cellulose or acrylic polymers. These organic agents satisfy the thickening function and enable obtaining homogenous ridge covers. However, these organic thickening agents disrupt the constitution of the inorganic network formed thus, severely harming the mechanical properties of the film. In fact, during the curing of the film, these organic agents are progressively destroyed, their volatile degradation products disrupting the network in formation and creating deficiencies in this same network. It results that the cohesion and solidity of the film formed are affected. Hence, one does not obtain the required hardness by using such coatings.

Furthermore, if the coating curing temperatures are kept low (which can constitute an advantage for sol-gel type coatings, particularly of organo-mineral nature), an accumulation of faults is observed in the structure of the formed sol-gel material.

Finally, in the case of culinary applications, one of the main benefits of sol-gel type coatings being linked to the possibility of being used at very high temperatures, for example equal or higher than 300° C., there is a risk of degradation for the user.

### SUMMARY OF THE INVENTION

The applicant has now found that the use of inorganic thickening agents in vitreous-type coatings, would enable to remedy to this issue of homogenous cover of the ridges of a structured bottom.

More particularly, an object of the present invention is a culinary article having improved non-stick properties, comprising a substrate exhibiting an internal side able to receive food and an external side to be arranged towards the heat source, the internal side being covered with a PTFE-free non-stick vitreous-type coating, wherein:
the non-stick coating is exhibited in the form of a continuous film having a thickness of at least 10 μm and which is constituted of a sol-gel material comprising a matrix of at least a metal polyalcoxylate, at least 5% by weight with respect to the total weight of the coating of at least one colloidal metal oxide dispersed in the matrix, and 0.01% to 10% by weight with respect to the total weight of the coating of at least one inorganic thickening agent, and
the internal side of the substrate is structured macroscopically such as to exhibit a relief with local variations of the surface level of an extent comprised between 100 μm and 5000 μm.

The structuring of the internal side covered in non-stick coating not only enables improvement of the non-stick properties of the coating, but also and especially to increase its wearability.

Thus, all things being equal (particularly the hydrophobic properties and those of mechanical resistance of the non-stick coating), a culinary article whereof the internal side is coated with a vitreous coating will exhibit a much faster decrease in its anti-adhesion during cooking tests of various foods if its surface is smooth with respect to the same article whereof the internal side has been structured in accordance with the present invention.

The relief of the internal side may consist of a plurality of regularly spaced ribs, preferably circular and concentric, or spiral-shaped or even in a plurality of cells.

In the case of a “cell” type relief, the latter can be of regular shape or not, arranged in a regular manner or not, and of constant density or not. Particularly, the cells can be polyhedrons arranged regularly such as to give the internal side of the substrate the appearance of a honeycomb. These cells may also be of circular shape and be arranged such as to give the internal side of the substrate the appearance of a golf ball. The cells may also be irregular-shaped corrugations such as to give the internal side of the substrate a dented effect or a “leather” effect according to the size of the pattern. The density of these cells cannot be constant over the entire internal side of the article. For example, the pattern on the bottom of the article may be narrower than on the skirt.

Pertaining to the coating covering the structured internal side, and particularly the sol-gel material constituting this coating, the matrix of this material may comprise metal polyalcoxylate condensation products, for example one or several metal polyalcoxylates, an aluminate, a titanate, a zirconate, a vanadate, a borate or a combination of these.

Preferably, the coating matrix according to the invention comprises a polyalkoxysilane and/or an aluminate such as to constitute a mixed matrix.

In an alternative embodiment of the invention, the matrix of the coating according to the invention is grafted by one or several organic groups selected amongst C₁-C₄ alkyls and phenyl groups. These groups are essential for improving the coating hydrophobicity. In order to obtain a better thermal stability for the coating, the short chains are privileged in the scope of the present invention. The weak steric hindrance of C₁-C₄ alkyl groups further enables them to be partially protected from a possible thermal degradation by the inorganic network.

Preferably, the matrix of the coating according to an embodiment of the invention is grafted by one or several methyl groups, which improve the hydrophobic character of the coating without hindering the inorganic network formation

As well as the matrix of at least one metal polyalcoxylate, the vitreous coating according to an embodiment of the invention comprises at least 5% by weight, and preferably from 5 to 30% by weight with respect to the total weight of the coating of at least one metal oxide, which is preferably finely dispersed in the matrix. This metal oxide is generally in the form of colloidal aggregates, whereof the size is less than a micron, even at 300 or 400 nm.

By way of colloidal metal oxide which can be used in the non-stick coating according to an embodiment of the invention, one may particularly cite silica, alumina, cerium oxide, zinc oxide, vanadium oxide, titanium oxide and zirconium oxide. Preferred colloidal metal oxides are silica and alumina.

The presence of metal oxide in the matrix of the coating according to an embodiment of the invention enables obtaining a film of sufficient thickness, namely, a thickness of around 10 μm. If the thickness of the coating is less than 10 μm, the mechanical resistance of the film formed is insufficient.

The vitreous coating also comprises 0.01% to 10% by weight with respect to the total weight of the coating of at least an inorganic thickening agent.

The inorganic thickening agents have a thermal stability such that their loss in weight (except for the water of constitution or hydration) is less than 1% after heating during 3 hours at 300° C.

In embodiments, the presence of an inorganic thickening agent in the sol-gel coating is necessary to enable a good covering of the relief ridges. In fact, this thickening agent substantially serves to regulate the viscosity of the sol-gel composition before its solidification, and second to monitor the shine of the final dry coating which is obtained.

By way of inorganic thickening agents that can be used in the scope of embodiments of the present invention, pyrogenic silicas and lamellar organic fillers (particularly in the form of layers) are advised.

In embodiments, the preferred inorganic thickening agents in the scope of the present invention are the lamellar organic fillers (particularly in the form of layers).

Amongst the lamellar organic fillers (in the form of layers) that can be used in the scope of embodiments of the present invention, one advises Laponite®, zirconium phosphate, or layered type clay (layer silicate) such as montmorillonite and talc.

In embodiments, the preferred lamellar inorganic filler (in the form of layers) in the framework of the present invention is Laponite®.

Preferably, in embodiments, the film has a thickness comprised between 10 and 80 μm, and better between 30 and 50 μm such that the skin thus formed is continuous, coherent and sufficient to absorb the roughness of the substrate.

Advantageously, the sol-gel material constituting the non-stick coating may further comprise at least a silicone oil to improve the hydrophobic character of the coating surface, and particularly after thermal aggression of flame passage type.

In fact, the metal polyalcoxylate exhibits hydrophobic groups that are destroyed at high temperature during a passage through a flame. However, this disappearance of hydrophobic character is momentary as it is progressively compensated by the silicone oil trapped in the polyalcoxylate and whereof the surface migration in infinitesimal quantities favors the progressive reconstitution of hydrophobic groups at the surface of the film.

One may observe that with a coating according to embodiments of the invention comprising at least 0.1% by weight of silicone oil, the reconstitution of the hydrophobic character is sufficient at the time of a new cooking. In fact, the value of the static Θ contact angle of a water droplet deposited on the coating of the invention is about 20° after thermal aggression of flame exposure type. This static contact angle value rises up again to at least 75° after a process of reconstituting hydrophobic properties consisting in a reheating of the ambient temperature at 200° C., over a period of at least 5 minutes, i.e., when the utensil is ready for a new cooking.

Preferably, the silicone oil represents 0.1 to 6% by weight and better 0.3 to 5% by weight of the total coating weight (dry basis). Under 0.1% by weight of silicone oil, the reconstitution of hydrophobic groups that have disappeared during a passage through the flame (600° C.) is lesser, the angle obtained being less than 62°.

More preferably, the sol-gel material of the coating according to embodiments of the invention comprises 0.5 to 2% by weight of silicone oil with respect to the total weight of the dry coating. In this case, the initial static contact angle Θ of a water droplet deposited on such a coating is of 95°. This coating after a thermal aggression of flame exposure type exhibits an angle of 20°. After a reconstitution process comprising at least a step of reheating of the ambient temperature at 200° C. over a period of at least 5 minutes, the static contact angle becomes greater than 75° when the utensil is ready for a new cooking.

This improvement of the hydrophobic character linked to the presence of silicone oil in the vitreous coating widely contributes to improving the non-stick properties of the coating.

The coating according to embodiments of the invention may comprise a silicone oil or a mixture of silicone oils.

By way of silicone oils that can be used in the coating according to embodiments of the invention, one may particularly cite phenyl silicones, methyl-phenyl silicones and methyl silicones.

If the coating according to embodiments of the invention is used to be in contact with foods, a food grade silicone oil will be preferred, and particularly an oil chosen amongst the methyl-phenyl silicones and food grade methyl silicones.

By way of methyl-phenyl silicon oils, one may particularly cite non edible oils commercialized by the WACKER company under trade name WACKER SILICONOL AP150 and by the DOW CORNING company under trade name DOW CORNING 550 fluid, as well as edible oils commercialized by company WACKER AR00. By way of methyl silicones, one may also cite the oil commercialized by company RHODIA under brand name RHODIA 47 V 350, the oil of company WACKER 200 fluid, or even the oil of company TEGO ZV 9207, which are food grade methyl silicone oils.

Preferably, a silicon oil chosen amongst those mentioned above will be used, with a molecular weight of at least 1000 g/mol, which is non reactive with a viscosity between 20 and 2000 mPa·s.

Advantageously, the sol-gel material of the coating according to embodiments of the invention may further comprise fillers to improve the mechanical properties of the coating that has been formed, and/or of the pigments to confer color to the coating. Furthermore, the presence of fillers and/or pigments also has a beneficial effect on the hardness of the film.

By way of fillers that can be used in the coating according to the invention, one may particularly cite, alumina, zirconia, mica, clays (such as montmorillonite, sepiolite, gypsite, kaolinite and Laponite®) and zirconium phosphate.

By way of pigments that can be used in the coating according to embodiments of the invention, one may particularly cite titanium dioxide, mixed oxides of copper-chromium-manganese, iron oxides, carbon black, pyralene red, aluminosilicates, metal flakes and particularly aluminium flakes.

Preferably, the pigment and/or the fillers are in the form of flakes, thus having the advantage of improving the hardness of the non-stick coating.

Preferably, the pigment and/or the fillers are of nanometric size, in order to improve their dispersion and distribution in the coating, giving it a great regularity of performance.

In an advantageous version of the culinary article according to embodiments of the invention, the substrate is a hollow cap of a culinary article, having a bottom and a lateral wall rising from said bottom.

The substrate of the culinary article according to embodiments of the invention is made from a material selected from metals, wood, glass, ceramics and plastic materials.

By way of metal substrates that can be used in the method according to embodiments of the invention, one may advantageously cite aluminium substrates or aluminium alloys, anodized or non anodized, in stainless steel, cast iron, iron or in copper.

The present invention also relates to a method for manufacturing a culinary article according to the invention, this method comprising the following steps made on a substrate:

a) providing a substrate with a first side to constitute the internal side of the article, and a side opposite to the first side and for forming the external side;

b) creating a macroscopic relief on the side to constitute the internal side of the substrate by a sizing operation such as to create variations at the surface in order to obtain a macroscopically structured internal side;

c) preparing a sol-gel composition comprising:
c1) preparing an aqueous composition A comprising 5 to 30% by weight with respect to the total weight of the aqueous composition A of at least a metal oxide, and 0 to 20% by weight with respect to the weight of composition A of a solvent comprising at least an alcohol, and 0.02 to 20% by weight of at least an inorganic thickening agent with respect to the weight of composition A;
c2) preparing a solution B comprising at least a metal alkoxide precursor type;
c3) mixing solution B of metal alkoxide with aqueous solution A in order to obtain a sol-gel composition (A+B) with 40 to 75% by weight of aqueous composition A with respect to the weight of the sol-gel composition (A+B), such that the quantity of colloidal metal oxide represents 5 to 30% by weight of the sol-gel composition (A+B) on a dry basis;

d) applying on the entirety or on part of the structured internal side of the substrate of at least a layer of the sol-gel composition (A+B) having a thickness of at least 20 μm on a wet basis, then
e) curing said sol-gel composition layer in order to obtain a vitreous coating of at least a 10 μm thickness.

By internal side of the article, is meant herein, the side to be arranged on the side where the food is liable to be introduced into the article.

By external side of the article, is meant herein, the side to be arranged on the side of a heat source.

Advantageously, the creation of the macroscopic structure on the internal side of the substrate may be carried out by a sizing operation. It is preferably used an already preformed substrate, i.e., a substrate exhibiting the final shape of the culinary article. However, it is also possible to use a plane substrate such as a disk. In this case, the method comprises a step of shaping f) by drawing the disk to give it the final shape of the culinary article.

Advantageously, the relief comprises a plurality of ribs or cells whereof the depth is comprised between 100 μm and 5 mm.

As for the preparation of the aqueous composition A, it is essential to incorporate at least 5% by weight of at least a metal oxide with respect to the total weight of composition A to form a film having after curing a thickness of at least 10 microns. If however, there is more than 30% by weight with respect to the weight of composition A, the latter is no longer stable.

The metal oxide of the aqueous composition A is such as defined above, and preferably selected amongst colloidal silica and/or colloidal alumina.

The inorganic thickening agent of aqueous composition A is such as defined above, and preferably selected amongst the inorganic lamellar fillers in layers such as Laponite®. This thickening agent has as function to regulate the viscosity of the sol-gel composition, as well as the shine of the dry coating.

The presence of an alcohol-based solvent is optional, but has the advantage of improving the compatibility of the aqueous composition A with the metal alkoxide solution B.

It is nevertheless possible to work without a solvent, however, in this case the choice of polyalcoxylates is limited to those having an excellent compatibility with water. An excessive quantity of solvent (greater than 20%), is possible but unnecessarily produces volatile organic compounds, harmful to the environment.

It is preferable to use by way of solvent in the aqueous composition A of the invention an oxygenated alcohol solvent or an ether alcohol.

The aqueous composition A according to embodiments of the invention may also comprise, in addition to the colloidal metal oxide and, if need be, the alcohol-based solvent, at least a silicone oil, which is preferably present in composition A at the rate of 0.05 to 3% by weight with respect to the total weight of the composition.

With an aqueous composition A comprising 0.5 to 2% by weight of silicone oil, one obtains a coating exhibiting hydrophobic properties that can be reconstituted in the framework of a process of culinary use. The silicone oil of composition A is a food grade silicone oil defined above.

The aqueous composition A in embodiments of the invention may also comprise fillers and/or pigments, that are such as defined above.

As for the preparation of solution B, it is preferable to use by way of precursor a metal oxide selected amongst the group constituted of:
precursors whose general formula is M₁ (OR₁)ₙ,
precursors whose general formula is M₂ (OR₂)₍ₙ₋₁₎R₂′, and
precursors whose general formula is M₃ (OR₃)₍ₙ₋₂₎R₃′₂, with

R₁, R₂, R₃ or R₃′ designating an alkyl group,

R₂′ designating an alkyl or phenyl group,

n being an integer corresponding to the maximum valence of metals M₁, M₂ or M₃.

M₁, M₂ or M₃ designating a metal selected among Si, Zr, Ti, Sn, Ce, V, Nb, Hf, Mg or Ln,

Advantageously, the metal oxide of solution B is an alkoxysilane.

By way of alkoxysilanes that can be used in solution B in embodiments of the method of the invention, may particularly be cited methyl trimethoxysilane (MTMS), tetraethoxysilane (TEOS), methyltriethoxylsilane (MTES) and dimethyldiethoxysilane, and their combinations, preferred alkoxysilanes being TEOS and MTMS.

According to an advantageous embodiment of the method of the invention, solution B may comprise a combination of alkoxylane such as defined above and an aluminium alkoxide.

The precursor type metal alkoxide of solution B is mixed with a Lewis organic mineral acid representing 0.01 to 10% by weight of the total weight of solution B.

By way of acids that can be used to mix with the metal alkoxide precursor, may particularly be cited acetic acid, citric acid, ethyl acetoacetate, hydrochloric acid or formic acid.

The preferred acids according to embodiments of the invention are organic acids, and more particularly acetic acid and formic acid.

After preparing the aqueous composition A and that of the precursor solution B, they are mixed together to form a sol-gel composition (A+B). The respective quantities of each one of the compositions A and B must be regulated so that the quantity of colloidal silica in the sol-gel composition represents 5 to 30% by dry weight.

The sol-gel composition (A+B) in embodiments of the invention may be applied on the substrate by spraying or any other application mode, such as soaking, stamping, with a paintbrush, with a roller, by spin-coating or serigraphy. However, in the framework of a shaped object, spraying for example by means of a spray gun has the advantage of forming a homogenous and continuous film, which after curing, forms a continuous coating, of regular thickness and leakproof.

After applying the sol-gel composition (A+B) according to embodiments of the invention, one usually proceeds by drying preferably at 80° C. during 3 minutes.

Depending on the nature of the required non-stick coating (organo-mineral or entirely mineral), the curing will be carried out:
either at a temperature higher than 400° C. and in this case one obtains, whatever the nature of the precursor, an entirely mineral coating,
or at a temperature lower than 400° C. and preferably between 180 and 350°, and in this case one obtains an organo-mineral coating (except if the precursor is only TEOS, as in this case an entirely mineral coating would be obtained, and thus, even at curing temperatures lower than 400° C.).

By way of substrate that can be used to achieve the culinary article according to embodiments of the invention, one will advantageously use a hollow cap such as described previously, having a bottom and a lateral side rising from the bottom.

The substrate that can be used within the framework of embodiments of the invention may advantageously be made from a material selected amongst metals, wood, glass, ceramics and plastic materials.

By way of metal substrates that can be used within the method according to embodiments of the invention, one may advantageously cite substrates in aluminium or in aluminium alloy, anodized or non anodized, in stainless steel, in cast iron and even in copper.

The method according to embodiments of the invention may further comprise a step of depositing a layer of enamel on the side that is opposite to that coated with a non-stick coating according to the invention, this step of depositing the layer of enamel being carried out prior to that of the non-stick coating according to the invention.

In addition to the above-mentioned advantages, the method in accordance with the invention is particularly simple to implement and may easily be considered without disrupting the standard manufacturing processes of culinary articles.

Other advantages and particularities of the present invention will become apparent from the following description, given by way of non limitative example and in reference to the accompanying drawings.

FIG. 1 is a cross sectional schematic view of a culinary article in accordance with the invention according to a first alternative embodiment (concentric circles);

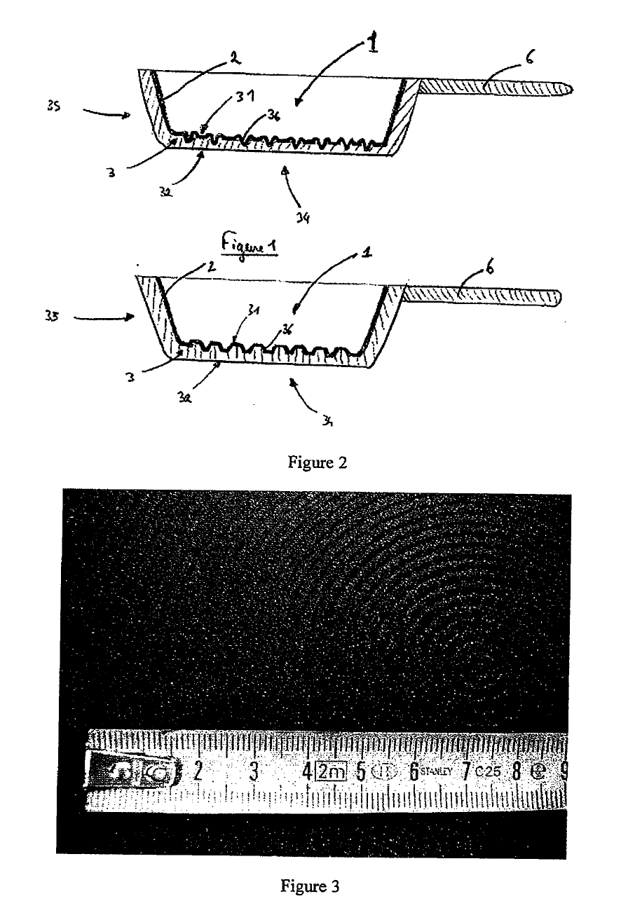

FIG. 2 is cross sectional schematic view of a culinary article in accordance with the invention according to a second alternative embodiment (honeycomb, coarse);

FIG. 3 is a top view of the internal side of the culinary article represented in FIG. 1 (concentric circles);

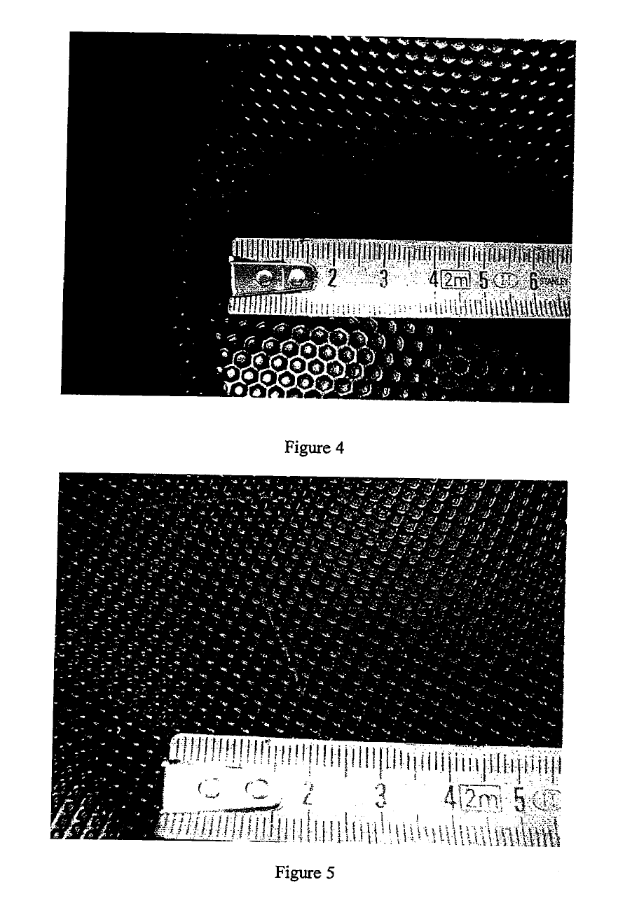

FIG. 4 represents a top view of the internal side of the culinary article represented in FIG. 2 (honeycomb, coarse);

FIG. 5 represents a top view of the internal side of a culinary article in accordance with the invention according to a third alternative embodiment with a relief analogous to that of the article represented on FIGS. 2 an 4, except that it is finer (honeycomb, fine);

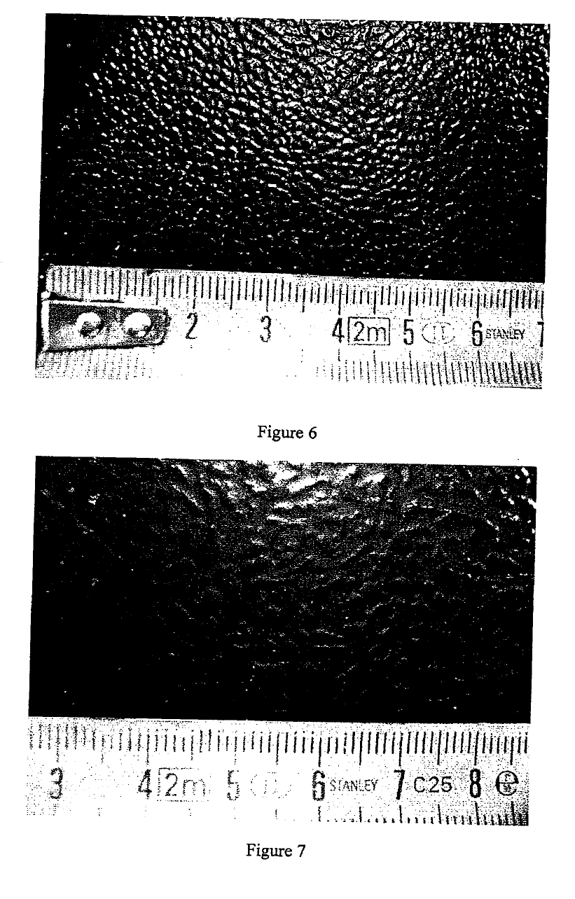

FIG. 6 represents a top view of the internal side of a culinary article in accordance with the invention according to a fourth alternative embodiment (“leather aspect”); and

FIG. 7 represents a schematic top view of the internal side of culinary article in accordance with the invention according to a fifth alternative embodiment (“sparse corrugations”).

### DETAILED DESCRIPTION

The identical elements represented on FIGS. 1 to 7 are identified by identical numerical references.

FIGS. 1 and 2, depict, by way of example of culinary article according to the invention, a frying pan 1 comprising a substrate 3 exhibited in the shape of a hollow cap with a bottom 34 and a lateral wall 35 rising from the bottom 34, and a grip handle 6. The substrate 3 comprises an internal side 31 able to receive food and an external side 32 to be arranged on the side of the heat source, such as a cooking plate or a burner.

The internal side 31 is coated with a non stick coating 2 of vitreous type in accordance with the invention.

FIGS. 1 and 2 show that the internal side 31 is structured macroscopically.

FIG. 1 particularly shows that the relief structuring this internal side 31 is exhibited in the form of regularly spaced grooves 36, and FIG. 3 shows that these grooves are in the form of concentric circles.

FIG. 2 shows more particularly that the relief structuring this internal side 31 exhibits cells and FIG. 4 shows that they are arranged in a honeycomb shape.

In the alternatives illustrated on FIGS. 5 to 7 is exhibited in form in top view other types of reliefs that can be used to macroscopically structure the internal side 31 of a culinary article in accordance with the present invention:
the relief of the internal side illustrated on FIG. 5 is analogue to that on FIG. 4 except that it is finer: honeycomb, fine,
the relief illustrated on FIG. 6 if of “leather aspect” type,
the relief illustrated on FIG. 7 is of “sparse corrugations” type.

The following examples illustrate embodiments of the invention without however limiting its scope.

In the examples, unless otherwise indicated, all quantities are given in grams.

### EXAMPLES

Products

Aqueous Composition A

Colloidal metal oxide: colloidal silica in the form of aqueous solution at 30% of silica, commercialized by the Clariant company under brand name Klebosol®.

Solvent: isopropanol

Silicone oil: food grade silicone methyl oil commercialized by the TEGO company under brand name TEGO® ZV 9207,

Pigment: black mineral pigment commercialized by the Ferro company under brand name FA 1260,

Inorganic thickening agent: synthetic layered silicate of sodium and magnesium commercialized by Rockwood under brand name Laponite® RD.

Solution B

Precursor: Methyl trimethoxysilane (MTMS) whose general formula is Si (OCH₃)₃CH₃,

Acid: acetic acid

Test

Accelerated Ageing Test of the Culinary Article by Intensive Cooking of Various Foods (Potatoes, Beans, Steaks, Grilling and Pancakes.)

Regularly during this accelerated ageing, the anti-adherence is evaluated by means of the egg test in accordance with the NF D 21-511 standard, and such as described as follows:
the internal side of a culinary article is oiled with a vegetable oil using a soft cloth, with a quantity of oil of about 2 cm³ of oil for a frying pan of a diameter between 240 mm and 280 mm;
then, the article is cleaned in warm water containing washing-up liquid, then rinsed first with warm water then with cold water and finally is dried;
afterwards, the adhesion resistance of a cooked egg is then monitored in the frying pan by proceeding as follows:
the frying pan is placed on a cooking plate such that its internal surface is heated to a temperature between 150° C. and 170° C.;
an egg is broken then cooked in the center of the frying pan without adding fat during 8 to 9 minutes;
when the egg is cooked, it is removed with a spatula;
then the frying pan is left to cool at ambient temperature; and
the frying pan is cleaned with a moist sponge.

The non-stick properties are linked to the ease with which the egg residue can be removed, in accordance with the previous operations according to following scale of values:
100 points are attributed if the whole egg comes off with a mere wrist shake,
50 points are attributed if the whole egg comes off with a spatula without leaving any residue,
25 points are attributed if the egg residue comes off by rubbing with a moist sponge,
0 points are attributed if the egg residue does not come off with a moist sponge.

### Example 1

### Preparing a Colloidal Silica-Based Aqueous Composition A

A colloidal silica-based aqueous composition A has been achieved, and is exhibited in table 1:

| Constituents of part A | Quantity (g) |
|---|---|
| Aqueous solution at 30% of | 42 |
| colloidal silica: Klebosol ® | |
| Water | 16 |
| Isopropanol | 8 |
| Black pigment FA 1220 | 32.5 |
| Silicone oil TEGO ZV 9207 | 1 |
| LAPONITE ® RD | 0.5 |
| TOTAL | 100 |

### Example 2

### Preparing an MTMS-Based Solution

A solution B is achieved by mixing 59.4 g of MTMS with 0.6 g of acetic acid, giving a solution at 1% by weight of the acid in the MTMS.

### Example 3

### Preparing a Sol-Gel SG Composition According to an Embodiment of the Invention

A first sol-gel composition SG is achieved according to an embodiment of the invention by adding, to 100 g of aqueous composition A according to the invention, 60 g of solution B. They are mixed during an hour in a planetary mixer by maintaining a temperature less than 60° C., after which a sol-gel composition is obtained according to an embodiment the invention SG which is kept at ambient temperature. The SG composition is left to mature during 24 hours at ambient temperature after mixing and prior to applying it on a substrate.

### Example 4

### Achieving a Culinary Article According to an Embodiment of the Invention (Internal Side with Relief)

As substrate, a piece having the final shape of a frying pan 1 is used, with a concave internal side 31 to be arranged on the side of the foods liable to be introduced into the article and a convex external side 32 to be arranged on the side of a heat source.

By sizing operation, a macroscopic relief is created on the surface of the internal side 31 of the substrate, such as any one of those represented in FIGS. 1 to 7.

Then, with a spray gun, the sol-gel SG composition is applied on the internal side 31 of the substrate of the example 3, according to the following cycle:
application on the substrate of a layer of sol-gel SG composition of example 3, with a wet-basis thickness of 40 to 70 microns,
drying during 3 minutes at 80° C., and
cooling at ambient temperature.

It is possible to apply this cycle several times, the number of cycles being determined by the required final thickness.

After the application/drying cycle(s), one steams during 15 minutes at 270° C. A coating is thus obtained exhibiting a dry thickness comprised between 30 and 70 microns, which is smooth black and shiny.

### Example 5

### Achieving a Reference Culinary Article (Internal Side without Relief)

As a substrate, the same one as example 7 is used, except for the fact that the internal side 31 is not subjected to a sizing operation which is intended for the structure, and remains smooth.

Then, for the depositing of the sol-gel SG composition of example 5 on the smooth internal side 31, one proceeds in the same manner as for example 4.

### Example 6

### Cooking Test

Intensive cooking cycles of several foods are carried out (potatoes, beans, steaks, grilling, pancakes).

Between each cooking cycle, the anti-adherence is monitored by the egg test according to standard NF D21-511.

The results of the egg tests having been carried out, obtained on the one hand with the frying pan of example 4 (with relief) and on the other hand with that of example 5 (without relief), are summarized in table 2 below.

TABLE 2

Results of the egg test

| | After 2 cooking | After 3 cooking |
|---|---|---|
| | cycles | cycles |
| Article according to an | 50 | 25 |
| embodiment of the invention | | |
| with macroscopic relief | | |
| (example 4) | | |
| Article of the prior art | 0 | 0 |
| (example 5) with smooth | | |
| surface | | |

The results exhibited in table 2 show that the creation of a macroscopic relief on the surface of the internal side makes it possible to improve the non-stick properties of the coating, and thus, durably.

1. A culinary article exhibiting improved hydrophobic properties, comprising a substrate having an internal side capable of receiving foods and an external side to be arranged towards the heat source, said internal side being coated with a PTFE-free non-stick coating of vitreous type, wherein:
said non-stick coating is formed as a continuous film having a thickness of at least 10 μm and constituted of a sol-gel material comprising a matrix of at least a metal polyalcoxylate and at least 5% by weight with respect to the total weight of the coating of at least a metal oxide dispersed in said matrix, and 0.01% to 10% by weight of at least an inorganic thickening agent with respect to the total weight of the coating, and
said internal side of the substrate is macroscopically structured and exhibits a relief with local variations at its surface in a magnitude varying from 100 μm to 5000 μm.

2. The culinary article according to claim 1, wherein the relief comprises a plurality of regularly spaced ribs.

3. The culinary article according to claim 1, wherein the relief comprises a plurality of cells.

4. The culinary article according to claim 1, wherein the metal polyalcoxylate is a polyalkoxysilane.

5. The culinary article according to claim 1, wherein the metal polyalcoxylate is an aluminate.

6. The culinary article according to claim 1, wherein the sol-gel material comprises a mixed matrix of polyalkoxysilane and aluminate.

7. The culinary article according to claim 1, wherein the metal oxide is a colloidal metal oxide selected from the group consisting in silica, alumina, cerium oxide, zinc oxide, vanadium oxide, titanium oxide and zirconium oxide.

8. The article according to claim 1, wherein the sol-gel material constituting said non-stick coating further comprises at least one silicone oil.

9. The article according to claim 8, wherein the silicone oil is selected from methyl-phenyl silicones and methyl silicones.

10. The article according to claim 8, wherein the silicone oil represents 0.1 to 6% by weight of the total weight of the coating.

11. The article according to claim 1, wherein the sol-gel material further comprises at least one filler and/or at least one pigment.

12. The article according to claim 11, wherein the pigment and/or the filler are in the form of flakes.

13. The article according to claim 11, wherein the pigment and/or the filler are of nanometric size.

14. The article according to claim 1, wherein the film has a thickness comprised between 10 and 80 μm.

15. The culinary article according to claim 1, wherein the substrate is made from a material selected from metals, wood, glass, ceramics and plastic material.

16. The culinary article according to claim 15, wherein the substrate is a metal substrate in anodized or non anodized aluminium, or in polished, brushed or microbead aluminium, or in polished, brushed or microbead stainless steel, or in cast iron or in hammered or polished copper.

17. A method for manufacturing a culinary article, comprising the steps of:
a) providing a substrate with a first side to constitute the internal side of said article, and a side opposite to said internal side and for forming the external side of said article;
b) creating a macroscopic relief on said first side such as to create variations at the surface in order to obtain a macroscopically structured internal side;
c) preparing a sol-gel composition comprising:
c1) preparing an aqueous composition A comprising 5 to 30% by weight with respect to the total weight of the aqueous composition A of at least a metal oxide, 0 to 20% by weight with respect to the weight of composition A of a solvent comprising at least an alcohol, and 0.02 to 20% by weight of at least an inorganic thickening agent with respect to the weight of aqueous composition A;
c2) preparing a solution B comprising at least a metal alkoxide type precursor;
c3) mixing solution B of metal alkoxide with the aqueous solution A in order to obtain a sol-gel composition (A+B) with 40 to 75% by weight of aqueous composition A with respect to the weight of the sol-gel composition (A+B), such that the quantity of metal oxide represents 5 to 30% by weight of the sol-gel composition (A+B) on a dry basis;
d) applying on the entirety or on part of the internal side of the substrate of at least a layer of the sol-gel composition (A+B) having a thickness of at least 20 μm on a wet basis,
then
e) curing said sol-gel composition layer in order to obtain a vitreous coating of at least a 10 μm thickness.

18. The method according to claim 17, wherein the relief comprises a plurality of ribs or cells the depth of which is comprised between 100 μm and 5 mm.

19. The method according to claim 17, wherein the metal oxide is a colloidal metal oxide selected from the group consisting in silica, alumina, cerium oxide, zinc oxide, vanadium oxide, titanium oxide and zirconium oxide.

20. The method according to claim 17, wherein the aqueous composition A further comprises at least one silicone oil.

21. The method according to claim 17, wherein the aqueous composition A further comprises at least one filler and/or at least one pigment, preferably in the form of flakes.

22. The method according to claim 17, wherein the precursor of metal alkoxide type of solution B is selected from the group constituted of:
precursors whose general formula is M₁ (OR₁)ₙ,
precursors whose general formula is M₂ (OR₂)₍ₙ₋₁₎R₂′, and
precursors whose general formula is M₃ (OR₃)₍ₙ₋₂₎R₃′₂,
with:
R₁, R₂, R₃ or R₃′ designating an alkyl group,
R₂′ designating an alkyl or phenyl group,
n being an integer corresponding to the maximum valence of metals M₁, M₂ or M₃,
M₁, M₂ or M₃ designating a metal selected from Si, Zr, Ti, Sn, Ce, V, Nb, Hf, Mg or Ln,

23. The method according to claim 22, wherein the metal alkoxide is an alkoxysilane, preferably selected from methyl trimethoxysilane (MTMS), and tetraethoxysilane (TEOS).

24. The method according to claim 17, wherein, on the structured internal side of substrate, two layers of the sol-gel composition are applied, so as to obtain, after curing, a layer thickness of 30 to 70 μm.
